(19) United States
(12) Patent Application Publication
(10) Pub. No.: US 2025/0117531 A1
(43) Pub. Date: Apr. 10, 2025

(54) METHOD FOR 3D Design

(71) Applicant: Tilbury Douglas Construction Limited, London (GB)

(72) Inventor: Alan Moylan, London (GB)

(21) Appl. No.: 18/908,128

(22) Filed: Oct. 7, 2024

(30) Foreign Application Priority Data
Oct. 6, 2023 (GB) 2315380.2

(51) Int. Cl. G06F 30/13; G06F 30/20

(52) U.S. Cl. CPC G06F 30/13; G06F 30/20

(57) ABSTRACT

The present invention relates to a method for repopulating a 3D design. The method for compressing a 3D model is also described. A system for performing the methods is also provided.

The method for repopulating a digital design of a building is provided comprises exporting one or more model files from a first project, importing the exported one or more files into a second project, and uploading one or more object files to the second project, wherein the one or more object files are matched to the exported one or more object files.

The method for compressing a 3D model comprises determining a decimation range for a number of objects, and removing polygons for the objects based on the decimation range.

### TECHNICAL FIELD

The present invention relates to a method for repopulating a 3D design. The method for compressing a 3D model is also described.

### BACKGROUND

Web-based applications which allow users to create a design before the construction typically enable a user to insert parts such as furniture, fixtures and equipment into a room or building such that the layout of a room can be designed. It has been appreciated that it would be desirable to improve web-based applications to improve user experience, enable compression of 3D models before their import into a web-based application, and enable repopulation of design exported from one application into another application.

### SUMMARY OF THE INVENTION

The invention is defined in the independent claims to which reference should now be made. Advantageous features are set out in the dependent claims.

In a first aspect of the invention there is provided a method for repopulating a digital design of a building, the method comprising: receiving one or more model files, exported from a first application, the one or more model files corresponding to a first building design in a first project, the one or more model files comprising at least a geometry of the building and the first building design comprising one or more objects; importing the exported one or more model files into a second project; and importing, into the second project, one or more object files corresponding to the one or more objects within the first building design; and repopulating the first design into the second project by matching the one or more imported object files to the one or more model files.

This first aspect has the advantage of enabling a digital building design to be exported from a project in one application, and imported into another project. The design can be exported by exporting the model files, and then can be repopulated by importing the object files into the model files in the second project. This has the advantage that the design does not have to be rebuilt in the new project, and instead can be imported and repopulated which is more efficient.

Optionally each object in the first building design comprises an identification code, and wherein the importing of the one or more object files further comprises, for each identification code of the one or more objects in the first building design, importing an object file having an identification code corresponding to the identification code of the object in the first building design. This has the advantage that the object files can be imported, where the objects match the objects within the first building design. Therefore, the building design can be repopulated correctly. Furthermore, the use of identification codes enables a library to searched for a specific identification code, to find the correct object files to import.

Optionally, one or more object files are imported from a library. Further optionally the library is stored on a platform or second application, different from the first application. The platform is a digital platform or software platform. The platform enables one or more computer programs or applications to run. Further optionally the library is stored in Sovelia PLM.

Optionally the one or more object files are stored in a hard drive, server drive or cloud drive.

Optionally the repopulation is automatic.

Optionally the exported one or more model files are each industry foundation classes (IFC), and wherein the importing of the one or more model files into the second project comprises linking the one or more IFCs to the second project to form the second design.

Further optionally, after repopulating the first design in the second project, the method further comprises removing the one or more linked IFCs from the second project, or hiding the one or more linked IFCs from view.

Optionally, each of the one or more exported model files corresponds to a storey of the first building design, such that an imported model file is linked to each storey of the first design in the second project.

Further optionally, the one or more model files are aligned or stacked vertically, wherein the order of the one or more model files corresponds to the storey of the first design in the second project.

Optionally the one or more objects are one or more of: furniture, fixtures, equipment, mechanical equipment, electrical equipment, electrical fixtures, public health, plumbing, empty rooms, or predesigned rooms.

Optionally the first design is repopulated in a software application.

In a second aspect, there is provided a method for compressing a 3D model, comprising: associating each of a plurality of objects within a 3D model with one of a plurality of groups, wherein the plurality of groups comprises a first group and a second group; determining a decimation range for each of the first and second groups, wherein the decimation range determines a proportion of polygons in each object within each of the first and second group to be removed; removing one or more polygons from the objects of the first and second group, such that a compressed model is formed; exporting the compressed model as a first file; and exporting decimation information as a second file.

This second aspect has the advantage of enabling a 3D model to be compressed in size, such that it can be imported into an application. It has been appreciated that 3D models may comprise a number of polygons which provide detail which is not required when designing a building. Therefore, a number of polygons can be removed to compress the model, without losing too much detail. This enables the model to be output into a file and input into another application for use in designing a building. By exporting a file including the decimation information, it is possible to retain information about the original 3D model, for later use.

Optionally, prior to removing one or more polygons from the model, the method comprises centring the model on the origin and determining the coordinates of the 3D object. This has the advantage that the models have the same origin, so that when a building is designed, the relative positions of the object can be accurately calculated.

Optionally, the method further comprises calculating the area of the model and height of the model, wherein the calculations are performed prior to removing the one or more polygons from the objects.

Optionally the method further comprises calculating the grid size and if it is determined that the model does not fit a predetermined grid, rescaling or stretching the model to fit the predetermined grid, wherein the calculation is performed prior to removing the one or more polygons from the objects.

Optionally, the method further comprises optimising the model prior to removing the one or more polygons from the object, wherein the optimisation comprises one or more of: removing duplicated objects, removing duplicated materials, repairing any topology of the model, and repairing any CAD models.

Optionally, the method further comprises, prior to determining a decimation range: identifying one or more duplicate faces and/or one or more extra polygons contained within the model; and removing the identified duplicate faces and/or extra polygons. This has the advantage that the size of the file is reduced by removing faces and polygons which are not needed. Therefore, the decimation range is calculated based on polygons which are necessary to the model.

Optionally the method further comprises determining a category for each of the plurality of objects, wherein each category comprises one or more groups, and the decimation range for each of the one or more groups is individually determined.

Optionally the file size of the compressed model is between 10 and 15 MB.

Optionally the second file is a text document. This has the advantage that it is able to be read by a user or software.

Optionally the decimation information comprises the number of polygons in the initial 3D model, and the decimation range for each of the first and second groups in each category, model width, model depth, model height, model area, space name, Space Description, Space Long Name, Space Clear Height or Space Gross Volume. This has the advantage that the information about the original 3D model can be output and input into other applications.

Optionally exporting the compressed model comprises exporting the model as a GL Transmission Format Binary file (GLB). This has the advantage that the file can be input into an application, such as the configurator described herein.

In another aspect there is provided a system for repopulating a digital design of a building, the system comprising: an input interface configured to receive one or more model files exported from a first application, the one or more model files corresponding to a first building design in a first project, the one or more model files comprising at least a geometry of the building and the first building design comprising one or more objects; a processor configured to import the exported one or more model files into a second project; wherein the processor is further configured to import, into the second project, one or more object files corresponding to the one or more objects within the first building design; and wherein the processor is further configured to repopulate the first design into the second project by matching the one or more imported object files to the one or more model files.

In another aspect there is provided a computer program comprising instructions which, when executed by a computer, cause the computer to perform a method for compressing a 3D model. The method associating each of a plurality of objects within a 3D model with one of a plurality of groups, wherein the plurality of groups comprises a first group and a second group; determining a decimation range for each of the first and second groups, wherein the decimation range determines a proportion of polygons in each object within each of the first and second group to be removed; removing one or more polygons from the objects of the first and second group, such that a compressed model is formed; exporting the compressed model as a first file; and exporting decimation information as a second file.

### BRIEF DESCRIPTION OF THE DRAWINGS

Embodiments of the invention will now be described, by way of example only, and with reference to the accompanying drawings in which:

FIG. 1 illustrates a flow diagram of process according to an embodiment of the present invention;

FIG. 2 illustrates a user interface of a configurator according to an embodiment of the present invention;

FIG. 3 illustrates a user interface of an output from the configurator according to an embodiment of the present invention;

FIGS. 4A and 4B illustrate a flow diagram of a process according to an embodiment of the present invention;

FIG. 5 illustrates a flow diagram of a process for repopulating a 3D design according to an embodiment of the present invention;

FIG. 6 illustrates a flow diagram of a process for repopulating a 3D design according to an embodiment of the present invention; and

FIG. 7 illustrates a flow diagram of a process for compressing a 3D model according to an embodiment of the present invention.

### DETAILED DESCRIPTION OF EXAMPLE EMBODIMENTS

The present invention relates to a configurator which is a web-based application, i.e. a digital tool, or software, which enables a user to design a building virtually, i.e. the user can create a 3D digital building design. The user will be provided with a set of building blocks they can assemble a building with, wherein each building block links to important data about the block itself. The user can furnish the model within the configurator to provide a complete model of a building. This data about the block and each of its components may include one or more of cost estimates, manufacture and construction time estimates, carbon and embed carbon data and design life. As the user adds building blocks to the design, the information associated with the design is increased. Information about the design as a whole can be used to provide an overview of the project based on information linked to each block. Therefore, the designer can for example see the cost of the building, its carbon footprint, and construction time.

As will be discussed in this application, the information and the design model can be exported and used in another stage of the project, or in a different project. Therefore, the model can be reused without a designer requiring to rebuild the model.

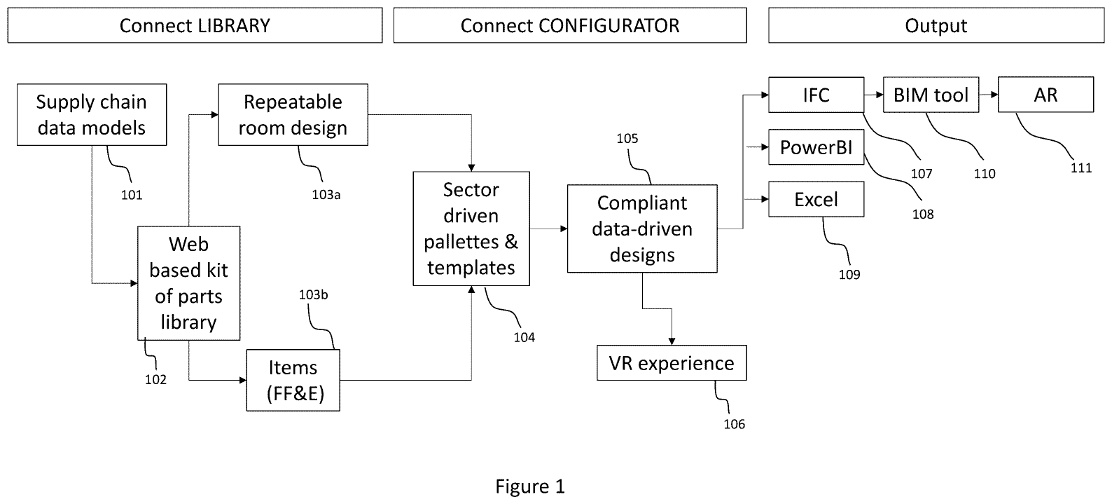

FIG. 1 shows an overview of the steps of the process of the configurator, as well as its input and output. FIG. 1 shows a particular embodiment of the invention.

As shown in FIG. 1, the first stage, i.e. the input, is the generation of a library. The library may be stored within a memory. The library may be input with data models of a supply chain 101. These data models are collated to form a web-based kit-of-parts library 102. The web-based kit of parts library can be used to generate a repeatable room design 103a, i.e. a pre-designed room. The repeatable room design is a room which comprises one or more objects within the room, and the user can either use the repeatable room without any changes, or they may personalise the room design with some additional features. Additionally or alternatively the library can be used to provide items such as FF&E (furniture, fixtures and equipment) 103b and MEP (mechanical, electrical and public health/plumbing) to furnish an empty room. This allows a user to design a unique or individual room, starting from an empty room, and inserting and placing and orienting objects within this room to result in a finished room.

As shown in FIG. 1, the modular room design 103a and the FF&E 103b can be input into the configurator and used to create palettes and templates 104. A palette is a collection of rooms and/or areas which may contain items such as FF&E. The palette may be collection of rooms and/or areas specific to a sector or usage, for example a healthcare palette may contain exam rooms and operating theatres. The user can therefore create designs which have the same rooms or areas, as the palette provides a repeatable part and therefore the user is not required to recreate the room or area each time. A template is a pre-designed model which contains rooms arranged in the 3D model space. An example of a template is a hospital layout. The user can interact with the template to build a 3D model. The template is a prepopulated design file which provides a starting point from which the user can build a design. The palettes and templates can be used in the configurator to create compliant data-driven designs 105. For example, a user can create a 3D model in the configurator starting with a template and inserting one or more palettes.

It has been appreciated by the invention disclosed herein, that it is beneficial for a user to be able to output the digital building design, so that the building design can be imported into a project in another application. By enabling the design to be exported and input into another program or application, the user, or another user, can continue building the design, or carrying out other functions on the building design. This is advantageous as the user does not have to rebuild the model, and instead can save time and money by continuing the design after it has been created in the configurator. The configurator can output the design, to VR (virtual reality) 106, such that the user can immerse themselves within the design, as discussed in more detail herein. The design and models can also be output to one or more of IFC (Industry Foundation Classes) 107, PowerBI 108, Excel 109. The output file can be used in a BIM (building information modelling) tool 110, and then this can be used in augmented reality (AR) 111. A BIM tool is a tool for creating a digital representation of assets combined into a intelligent model that describes the geometry of the building modules as well as their connections/relationships and associated metadata. In the BIM tool a user is able to continue working on the imported design.

The output from the configurator can be used as an input for another model, as will be described in more detail herein.

### Input

The input stage of the process will be described in more detail herein. The input stage comprises importing 3D models into the configurator, which can be used to build designs.

As described in relation to FIG. 1, supply chain data and models are stored in a library, which may be a web-based kit-of-parts library which includes standard parts and/or kit of parts. The library may be stored on a memory. The library may be continuously updated with new models. A user may be notified when a model has been updated and one or more out of date models are present in the user's design. The user can choose whether to update their design with new models. Some updates may be essential, and therefore the user will not be provided with an option to decline or accept the update. Instead, the design may be updated with the new model, and the user may be notified to inform them that the one or more models in the design have been updated.

The models and parts which form the models and files in the configurator may be imported from a Revit application, and converted into a suitable file for importing into the configurator. For example, the file may be a GLB (GL Transmission Format Binary file) file. Therefore, the library may be in a Revit application.

The memory on which the library is stored may be a data storage area which is located on a hard drive, server or cloud. Alternatively, the library may be stored in a product lifecycle manager software system (PLM), e.g. Sovelia PLM, or a suitable software application.

The 3D objects fed into the configurator are 3D models, which may be from a Revit application. Therefore the model may be in a .rvt, .rfa or glb format.

The 3D model files are reduced in size so that they can be imported into a configurator and added to a palette for use in other designs.

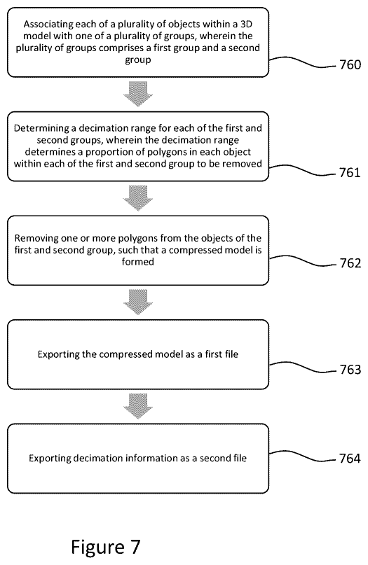

One embodiment is illustrated in FIG. 7. At step 760 each of a plurality of objects within a 3D model is associated with one of a plurality of groups, wherein the plurality of groups comprises a first group and a second group. At step 761 a decimation range is determined for each of the first and second groups, wherein the decimation range determines a proportion of polygons in each object within each of the first and second group to be removed. At step 762 one or more polygons are removed from the objects of the first and second group, such that a compressed model is formed. At step 763 the compressed model is exported as a first file. At step 764 decimation information is exported as a second file.

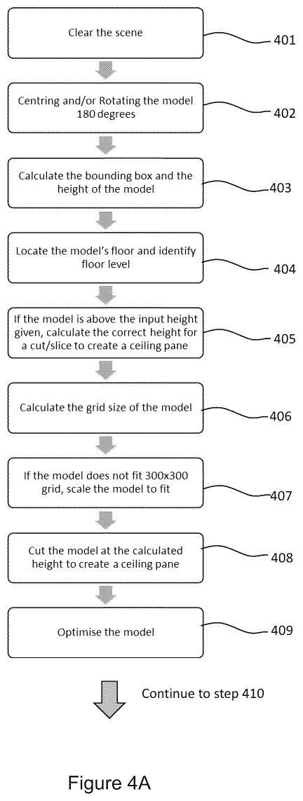

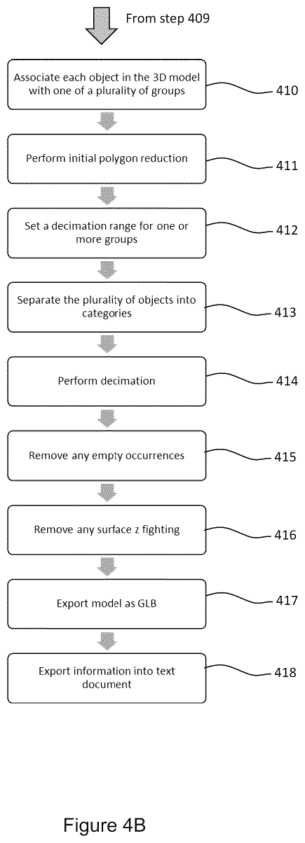

In one example a script is run to reduce the file size of the model and export the model as a GLB (GL Transmission Format Binary) file following the method described herein. The script may be a Python Script run in Pixyz. A method of reducing the file size and exporting the model as a GLB file to be used in a configurator is illustrated in FIGS. 4A and 4B, and described herein. It will be appreciated that the method may comprise a subset of the following steps, where it is not required for each of the steps to be performed.

At step 401 the script clears the scene. Therefore, the only model in the area is the model provided.

At step 402 it is ensured that the model is centred at the correct origin point, i.e. the model is located at 0,0,0 in 3D space. The model may be rotated, e.g. 180 degrees, to ensure it is exported in the correct orientation. The coordinates of the model are also calculated. Therefore, when the model is inserted into a design, its relative position and orientation to other models can be determined, as each model will have the same origin point.

At step 403 the script calculates the bounding box, i.e. area of the model, and height of the model for future calculations.

At step 404 the model's floor is located and the overall floor size of the model is calculated. The floor storey, i.e. floor level, of the model is also identified. The calculated floor size and the floor storey may be used in future calculations.

At step 405 the script calculates the correct height for a cut/slice to create a ceiling plane. This height is determined from the floor height and the model's overall height. The height is only determined if the height of the model is above the input height given. For example the input height may be set to 2500 mm. However, the input height can be changed. Once the input height is set, and the correct height for a cut/slice is calculated, this allows the room features e.g. furniture, to be visible from a top-down view, as the ceiling is effectively ‘hidden’.

At step 406, the model information calculated and identified in the steps above are used to calculate the grid size of the model.

At step 407, if the model does not fit on a 300 by 300 grid it is then scaled to fit. Therefore, the model may be rescaled or stretched to fit the grid. If the model already fits the grid, then step 407 is not carried out.

At step 408, the model is cut at the height calculated in step 405, creating a ceiling plane. Therefore, when a user is viewing the model in the configurator they can see the interior of the model. This ceiling plane does not affect the model outside of the configurator.

At step 409, the model goes through an optimization process. The optimisation process removes any duplicated materials, duplicated objects that may be located inside each other, repairs any topology of the model that may be out of place and repairs any CAD models. The CAD models may be incorrect, such that there may be parts of the CAD models that are missing, or other errors may be present in the CAD models which are corrected in this step.

At step 410 the model goes through an initial polygon reduction. This step makes the file size smaller for upload. This initial polygon reduction comprises looking for duplicate faces, and extra polygons contained within the files, which can be removed to optimise the file and reduce the size of the file. In this context, a polygon is collection of individual lines and points which combine to create an enclosed shape.

At step 411 each of the one or more objects in the 3D model are associated with one of a plurality of groups. There may be two groups, where for example one group is MEP and the other group is Furniture, or FF&E. It will be appreciated that the techniques described herein may be used for any number and type of groups.

At step 412 decimation range is set of each group, for example the decimation range for MEP may be set to 50% and Furniture to 20%. This will determine what percentage of polygons you want to remove from each of the objects in the MEP group, and the percentage of polygons you want to remove from each of the objects in the furniture group. The higher the number the more polygons will be removed from each object. The higher the decimation range is set, the more the model's quality may be affect as it may remove large portions of polygons reducing the object to its most simple form. Therefore, detail will be removed by the decimation. The decimation range may be determined based on the size of the original 3D model, and the required or preferred size of the compressed 3D model. The decimation range may be determined by a user, based on the detail required for each of the plurality of groups. It may be determined by the user which polygons to remove in each model, or this may be determined by software.

At step 413 the plurality of objects may further be separated into categories. The categories may be assigned to each of the objects in the 3D model before step 401. For example, for a model imported from Revit, each of the plurality of objects in the 3D model may have a category assigned to it. In other words, a list of categories is gathered from the original Revit model, as each object inside Revit is part of one of these families/categories. An example set of families/categories may be:

a. Furniture Types, b. Generic Models, c. Furniture, d. MEP Types, e. Lighting Fixtures, f. Mechanical Equipment, g. Pipes, h. Pipe Fittings, i. Pipe Accessories, j. Air Terminals, k. Ducts, I. Duct Fittings, m. Duct Accessories, n. Fire Alarm Devices, o. Electrical Equipment, p. Nurse Call Devices, q. Electrical Fixtures, r. Lighting Devices, s. Plumbing Fixtures.

Each category may further be split into two groups, furniture and MEP. Therefore, as described above, each of the plurality of objects is in either the furniture group, or the MEP group. The object may be decimated based on the decimation range for the corresponding group. The categories are decimated individually. For example, the furniture types are decimated separately to generic models. As described above, the furniture and MEP groups may have different decimation ranges, for example the decimation range for MEP may be set to 50% and Furniture to 20%.

At step 414, after the groups and optionally the categories have been determined, the script will perform the decimation by removing one or more polygons from the objects of the first and second group, i.e. the furniture group and the MEP group. At step 415 the script will remove any empty occurrences. Empty occurrences are parts of the model which are hidden or not needed.

At step 416 any surface z fighting is removed. Surface z-fighting are overlapping surfaces which cause a visual glitch.

At step 417 the 3D model which has been compressed, i.e. the compressed model, is exported as a GLB file. The GLB file is used to load palettes and rooms/areas for importing into the configurator. In one example, in which the configurator has a file size limit of 25 MB, the size of the compressed file must be under 2 5MB. In most examples it is preferable that the size of the file is between around 10 and 15 MB or lower. Most preferably the size of the file is 10 MB or lower.

At step 418 the information gathered in the steps above about the model is exported into a Text document. The information within the exported text document summarises one or more aspects of the original 3D model. This document contains the Width, Depth, Height, Gross area, IFC space name, IFC Space Description, IFC Space Long Name, IFC Space Clear Height, IFC Space Gross Volume, the number of polygons the model started with and the amount that the script reduced it by, i.e. the decimation ranges. The information in the text document can be used to be input into the configurator for each model. Therefore, the details about the original 3D model are available, and when a design is created a compressed 3D model, it is possible to determine the details of the original 3D model. Therefore, when the design is exported from the configurator, as will be described herein, it is possible to determine the details about the design using the details of the full original 3D model.

Following the above steps, one or more models may be converted into one or more GLB files, which have a reduced file size. The one or more GLB files can be imported into the configurator, and may be added to a palette to be used to create models. The text document may be input into the configurator, to provide information about the model. The information may be input into the configurator by a user, or the input may be automated such that the configurator reads the information from the text document.

### Configurator

As described in FIG. 1, the data is input into a configurator, in which a user can create a 3D design. An embodiment of the configurator is being described in more detail herein. The configurator is a web-based application, which is in communication with a database of files, where the files are GLB files. The database may be stored in the cloud, server or on a hard-drive. The GLB files may be one or more 3D models, which are able to be inserted into the design being built in the configurator.

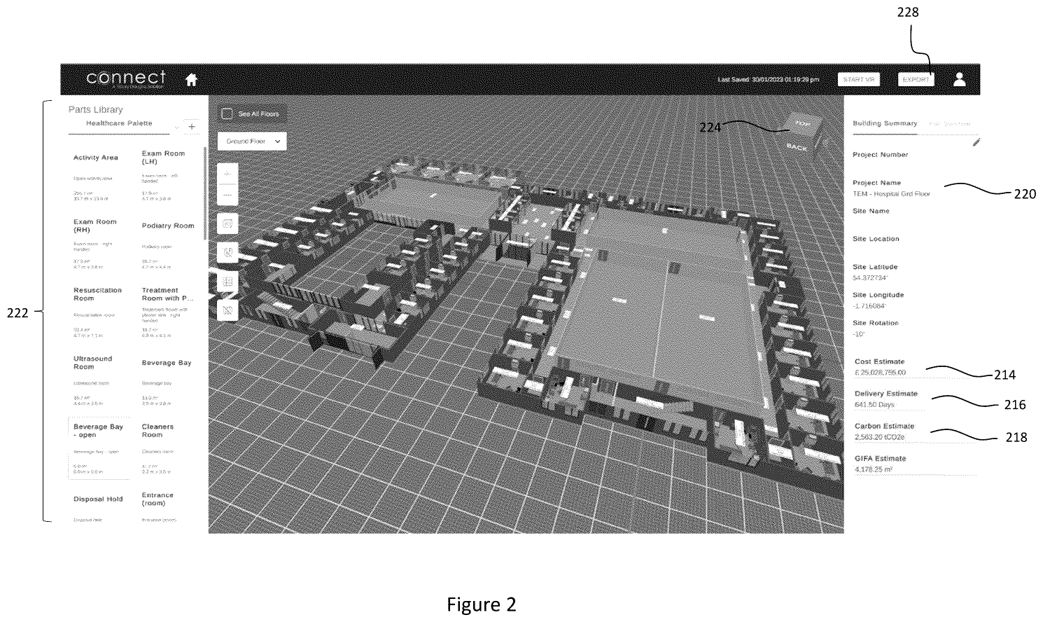

FIG. 2 illustrates an embodiment of the configurator. The configurator allows a user to create a multi-level building concept design, i.e. a building concept design with multiple storeys, based on repeatable room designs and layouts. The repeatable room designs are rooms which are furnished, for example the rooms comprises one or more FF&E (furniture, fixtures and equipment) and MEP (mechanical, electrical and public health/plumbing) items. The configurator enables a user to drag an empty room into the design space from a palette 222, and furnish the empty room as required by dragging in FF&E (furniture, fixtures and equipment) and MEP (mechanical, electrical and public health/plumbing) items from a palette, allowing a user to create a bespoke room in their design. The configurator is configured such that the user can place and move 3D models in a 3D space, allowing the models to be placed adjacent to each other on the same storey, and also allowing models to be stacked on top of each other over a number of different storeys. The 3D space of a configurator may be a 300×300×300 mm cubic grid 212 on which objects can be placed.

FIG. 2 shows the user interface of the configurators design space. In this particular example UI, the palette 222 is shown on the left of the screen, labelled as the Healthcare Palette. As will be understood, there may be multiple palettes, each with a number of rooms or areas etc. within the palette. The user can select one or more palettes from the library, to insert into the design.

The 3D design space is shown in the middle of the screen, and the information window is shown on the right of the screen.

Each model links to a database of information about the model itself, wherein the information may contain one or more of ID Code (alphanumeric characters making a machine-readable unique ID., version, Name 220 (alphanumeric characters making a human-readable name), Cost Estimate 214 (e.g. currency in £), Time Estimate for delivery 216 (e.g. integer for weeks), and carbon estimate 218 (float number). The information is be combined for all the models inserted into the design and updated by the configurator as the user adds additional models into the configurator. Therefore, for example, the total cost, time and carbon estimate for the design may be displayed to the user in the configurator. BIM (building information modelling) data may be accessed by a user, where the BIM data is associated with each of the imported models.

As will be described herein, the configurator may be configured such that the design can be saved and stored, so that the user can save and return to a design before completion.

The configurator shows the user which direction they are currently facing when viewing the design. As described in the input stage, each model comprises a size and orientation, and coordinates of the model. Therefore, the orientation and relative locations of all of the models within the design can be determined. This enables the configurator to show the user which way they are orientated within the design. For example, this could be by showing a cube 224 in the interface and shows which face of the cube, i.e. direction, the user is facing. This cube is described in more detail herein, in reference to a view cube.

The configurator user interface may enable the user to perform a number of actions. The configurator has a number of scripts that it may run to perform the actions. These actions may be carried out after the use of a button shown in the web-based application. FIG. 2 shows an embodiment of the user interface (UI) for the configurator. However, it will be appreciated that not all the possible actions or buttons are illustrated in the figure. The configurator may comprise a subset of any of the following actions, and it will be appreciated that the configurator is not required to have all of the actions described herein. The actions that the user can take may include some or all of the following:
1. Floors: This allows the user to switch between floors. For example, the user can switch the view from the first floor to the second floor. The user can switch the floors to enable the user to make changes to another floor. This action also gives the user the option to create floors above, below and remove the current floor that the user has selected.
2. See all floors: This allows the user to see all the floors inside a project.
3. Zoom in/out: In the user interface there is a plus and minus button that allows the user to zoom in and out of a project without requiring a scroll wheel.
4. 3D/2D viewer: This enables the user to switch between a 3D and 2D view.
5. Cube viewer: This shows user what direction they are currently facing. User can also click onto this view cube to move to the location or click on the top, front, back, left, and right to be placed in that directional view.
6. Magnet: This function enables the user to attach objects within the configurator together. For example, furniture will be attached so that the pieces of furniture are adjacent to each other. When this function is not enabled, the user can either manually place the furniture apart or adjacent to other pieces of furniture.
7. Grid: This adds a 300 by 300 grid plane to all projects and layers.
8. Grid on/off: This allows the user to turn the grid layer on and off.
9. Map: This turns a map on and off. The longitude, latitude and rotation of a location can be input into the project for a map layer to appear in the project. This action can only be performed if the required information is provided to the configurator.
10. Drag and drop: This allows a user to select a model and drag it into a project.
11. Home Button: This brings the user back to the main page.
12. Settings button: This brings user to the settings page that contains the following tabs:
   a. Profile: This shows user their email.
   b. Password: This allows a user to change your password.
   c. Two factor authentication: This allows a user to set up an authentication app.
   d. Personal data: This allows a user to download the data the application stores and delete this data.
   e. Palettes: This enables a user to add new palettes and edit current palettes and templates. This action may only be available for specified people, for example for an administrator.
13. Palette selector/add another palette: This allows user to change and add new palettes to their current project.
14. Palettes: The palettes are made up of models that have been processed through Pixyz, using a Python Script. Inside the palettes users can edit all the specific details for example cost, dimensions, IFC data. This action may only be available for specified people to perform, for example administrators.
15. Start VR: This opens the VR tab allowing for user to: add hotspots to set up viewing spots in VR, edit these hotspot locations, delete the current (or all) hotspots, and see the path user will take in VR when the hotspot locations are linked. After selecting the Start VR button 226, user will be required to input a code that can be found in the VR application on their VR headset. There is also Stop VR button to end the VR session.
16. Export: By pressing the export button 228, this allows user to export the project into the following file formats: PNG, IFC, SVG, CSV and JSON as will be described herein.
17. Building summary: This gives user an overall summary of the current project: Cost estimate, Delivery estimate, Carbon estimates, GIFA estimate, as well as basic project details. In the top right there is an edit function so user can edit a project's data if needed.
18. Part summary: This shows user the details relating to the current selected objects.
19. Last saved updater: Updates every time user place an object into the project and when user exit the project. This displays the date and time it was last edited.
20. New project: This will open a tab where user can input the details of the project, choose your palettes, and a template (if one is available).
21. Project import: This allows user to import projects that others have sent user.
22. Project open: Click on a project to open it.
23. Project delete: In the top right of all projects there are three grey dots that can be clicked to delete a project

As described above, the configurator may indicate the direction in which the user is facing within the model space. In one embodiment, the model space in the configurator has a centre point, 0,0,0 from which the location and direction of rooms and palettes within the model may be calculated. The centre point is not related to real world coordinates. The user may insert a real world map to the configurator which may underly the design, such that the user can use the map as a reference point for the rooms and features within the model. In this embodiment the real world map does not import any coordinates into the configurator. The map can be rotated to match the grid or view cube to orientate the layout. The view cube as described herein may be used to orientate the user, for example by showing up, down, left, right, top and bottom, so that palettes, rooms and features can be oriented in the model.

As noted above, the configurator may be configured to enable VR to be used to provide a view of the design. Therefore, the web application is connectable to a VR system. It is possible for a user to create a path within the design, such that the user can walk through the design along the path. This allows the user to better position themselves within the space. The user can use VR to view ‘hotspots’ within the design, i.e. to set up viewing spots within the VR. The position of the blocks within the configurator design is determined, such that the user can navigate through the design. As described herein, the models are 3D models within 3D space. Therefore, the VR can envision the height, depth, multiple layers of the building blocks.

### Output

As described in relation to FIG. 1, after a concept design is complete, the user may output, i.e. export, the information into various formats. The exported information may be used to repopulate a digital design of a building.

The user can export any of the following types and formats of information for further use: image file (e.g. PNG), vector graphic plan views at each building storey (e.g. Scalable Vector Graphics, SVG), data set of the 3D models used in the design and their attached information (e.g. comma-separated values, CSV), information for use in further design development (Industry Foundation Classes, IFC), and/or information for configuration design/project sharing (JavaScript Object Notation, JSON). The exported data may comprise one or more of Name, ID and version for the one or more models of the design so that exported data can be related back to the design.

The user may export a plan of each storey, i.e. floor of the building, or of each selected storey into one or more of the data types.

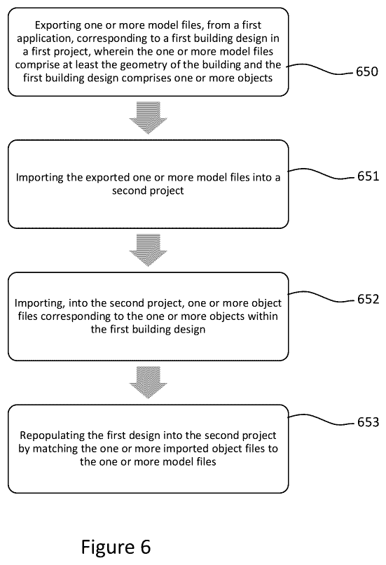

In one embodiment shown in FIG. 6, at step 650 one or more models are exported from a first application, corresponding to a first building design in a first project, wherein the one or more model files comprise at least the geometry of the building and the first building design comprises one or more objects. At step 651, the one or more exported model files are received at an input interface, and the one or more exported model files are imported into a second project. The one or more exported model files may be imported by a processor. At step 652 one or more object files corresponding to the one or more objects within the first building design is imported into the second project, the importing of the one or more object files may be by a processor. At step 653 the first design is repopulated into the second project by matching the one or more imported objects files to the one or more model files. The repopulation may be by a processor.

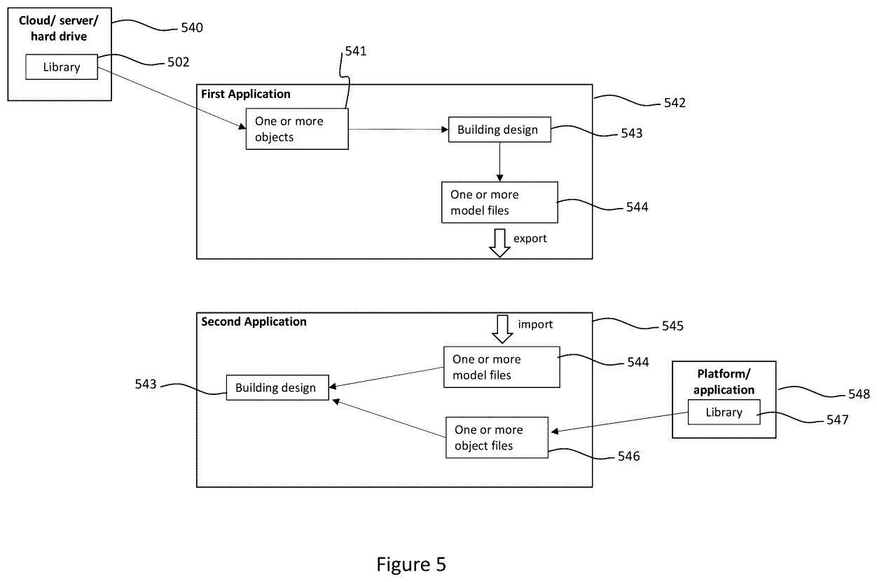

In one example, shown in FIG. 5, one or more model files are exported from a first application 542, e.g. the configurator described herein, where the one or more model files 544 correspond to a building design 543 in a project in the configurator, i.e. the first project. The model files can be mass block files, for example one or more IFCs. The building design created within the configurator comprises one or more objects 541, where, for example the objects may be repeatable room designs, or empty rooms and FF&E and MEP. The one or more objects are input into the configurator from a library 502, which may be stored on a cloud, or server, or hard drive 540, as described herein. Each of the objects may comprise an identification means which enables the object to be identified. For example, the identification means may be an identification code. For example the identification means may be a serial number, a barcode, a QR code, or another suitable means by which the object can be identified. The exported one or more model files comprise the geometry of the building, for example the model files comprise an outline of the building and an outline of the rooms within the building. The one or more model files also comprise the unique identification means for each of the objects, where the unique identification means enables an object to be placed at the correct location and can have the correct orientation. For example, a unique identification code may be located in a specific place within the model file for an object, so that an object in the library with the matching identification code can be imported into the second project and placed in the same place and orientation as the object in the building design in the first project. Therefore, the completed building design will comprise the same objects, in the same orientations and locations, as the building design within the configurator.

The second project may be located in a different application 545, for example, the second project may be located within software application on a computer, for example a BIM tool, such that the exported one or more model files are uploaded into a BIM tool. The BIM authoring tool may be Autodesk Revit such that a user may continue the design in a Revit project template, however any other suitable tool may be used.

An object file 546 is imported into the second project for each identification code in the one or more model files. The object file may for example be one of furniture, fixtures, equipment, mechanical equipment, electrical equipment, electrical fixtures, public health, plumbing, empty rooms, or predesigned rooms. The imported object file has an identification code which matches the identification code located in the model file. For example, if the model in the configurator comprises an object, the unique identification code for this object is located in the exported model file, and therefore the same object can be inserted into the imported model file in the second project. Therefore the design 543 can be repopulated by matching an object to each identification code within the one or more model files. It will be appreciated that if there are more than one of an identical object located within the design in the first application, the identical objects may have the same identification code. The one or more object files are imported from a library 547. This library may be a web-based library of parts, which for example is stored within Sovelia PLM or may be stored on SharePoint or OneDrive. This library may be different to the library used to import 3D models into the configurator, as described above. The library can be stored on any platform or application 548 from which the second application, e.g. a BIM tool, can import the one or more files. Alternatively, the library may be stored on a hard drive, server drive or cloud drive. In some examples, the repopulation of the design in the second project may be automatic. For example, the second application may automatically match the one or more object files with the one or more model files. In other examples, the user may start a search and find process within the second application, which starts the matching process by searching the library for an object with a matching identification code.

The building design may be exported from the first application, and imported into the second project separated into storeys, e.g. levels. For example, there may be a separate model file for each storey of the building, e.g. ground floor, first floor, second floor, etc. This has the advantage that a user who is working on the repopulated design in the second project, can alter the storey order, or can remove one storey on its own, or can import for example a new first floor to replace the imported first floor. Therefore, this gives the user more ability to alter the design when it has been repopulated. However, in some embodiments the building design may be exported as a whole deisgn, i.e. as single file, where all of the storeys of the building are contained within one model file.

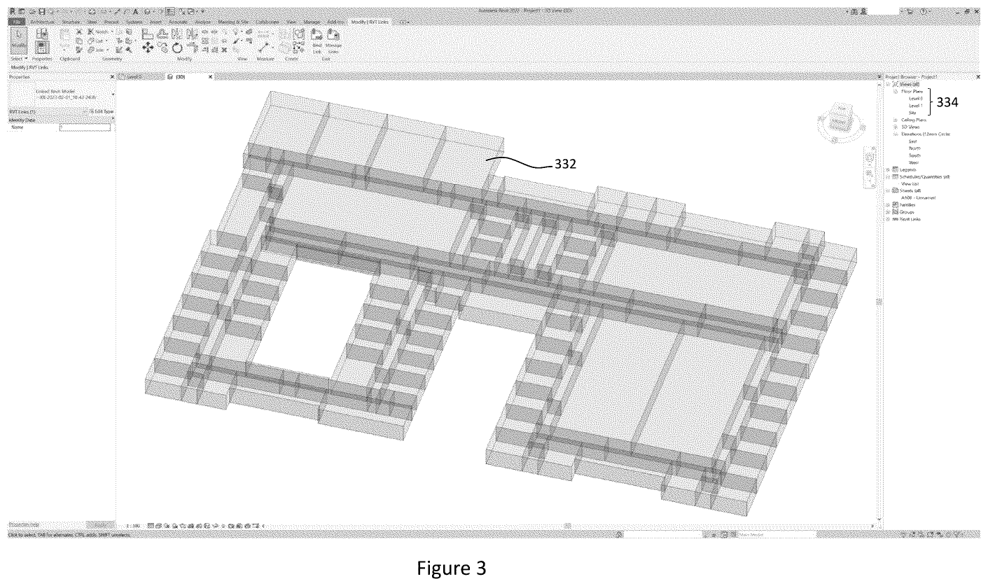

FIG. 3 shows an example in which the first building design is exported as IFC output. In this example, the steps disclosed above of the process for exporting one or more model files from a first application, and importing the model files and object files into the second project, are carried out. Each storey 334, i.e. level, of the building design can be exported to an IFC. As described above, the information may be input into a BIM (building information modelling) authoring tool, which enables the design team to further develop the design. The exported IFC model may have BIM metadata defined in the palette.

FIG. 3 shows the view in Revit where the IFC from the configurator has been linked into a project. As shown, the IFC represents each room 332 and each item used in the room as a mass object. A designer can repopulate the design using the mass as a placeholder to do so from. The IFC is like an underlay that can be traced over with actual Revit geometry, or the native geometry types of the BIM authoring tool being used by the design team(s).

When importing the IFCs, each IFC is linked to a particular storey 334, and aligned or stacked vertically to correspond to the storey.

After the IFCs have been aligned and/or stacked, the user can select a location at which the object files are saved, and select some or all of the files to import. Alternatively, if the library of parts are stored on another platform such as Sovelia PLM, the user can find the library of parts to repopulate the design.

The user selects a linked IFC, and the application will determine the object files to match to the masses in the selected IFC, based on the identification code of each object file. The determined object files will be placed over the corresponding mass. After matching of the object files to each of the masses in each of the one or more IFCs, the linked IFCs can be removed so that the IFCs are not visible in the design. Alternatively, the linked IFCs can be hidden from view, without being removed from the design. After removal or hiding of the linked IFCs, the detailed design has been repopulated and the user can begin designing a second design using the repopulated first design as a starting point.

The invention therefore results in the user not being required to re-design the same items and configurations to use in another project. Therefore, the invention results in an improved process for designing a room or building in a web-based application. The method of importing the design into a second project has the advantage of improving user experience and improving efficiency of building a design.

The system described above may comprise a Graphical User Interface. Embodiments of the invention may include an on-screen graphical user interface. The user interface may be provided, for example, in the form of a widget embedded in a web site, as an application for a device, or on a dedicated landing web page. Computer readable program instructions for implementing the graphical user interface may be downloaded to the client device from a computer readable storage medium via a network, for example, the Internet, a local area network (LAN), a wide area network (WAN) and/or a wireless network. The instructions may be stored in a computer readable storage medium within the client device.

As will be appreciated by one of skill in the art, the invention described herein may be embodied in whole or in part as a method, a data processing system, or a computer program product including computer readable instructions. Accordingly, the invention may take the form of an entirely hardware embodiment or an embodiment combining software, hardware and any other suitable approach or apparatus.

The computer readable program instructions may be stored on a non-transitory, tangible computer readable medium. The computer readable storage medium may include one or more of an electronic storage device, a magnetic storage device, an optical storage device, an electromagnetic storage device, a semiconductor storage device, a portable computer disk, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk.

Various modifications to the example embodiments described above are possible and will occur to those skilled in the art without departing from the scope of the invention which is defined by the following claims. In particular, it should be understood that features described in relation to a single embodiment can be present in other embodiments.

1. A method for repopulating a digital design of a building, the method comprising:
receiving one or more model files, exported from a first application, the one or more model files corresponding to a first building design in a first project, the one or more model files comprising at least a geometry of the building and the first building design comprising one or more objects;
importing the exported one or more model files into a second project; and
importing, into the second project, one or more object files corresponding to the one or more objects within the first building design; and
repopulating the first design into the second project by matching the one or more imported object files to the one or more model files.

2. The method of claim 1 wherein each object in of the first building design comprises an identification code, and wherein the importing of the one or more object files further comprises:
for each identification code of the one or more objects in the first building design, importing an object file having an identification code corresponding to the identification code of the object in the first building design.

3. The method of claim 1 wherein the one or more object files are imported from a library, the library being stored on either a platform or a second application that is different from the first application.

4. The method of claim 1 wherein the one or more object files are stored in a hard drive, server drive or cloud drive.

5. The method of claim 1 wherein the repopulation is automatic.

6. The method of claim 1 wherein the exported one or more model files are each industry foundation classes (IFC), and wherein the importing of the one or more model files into the second project comprises linking the one or more IFCs to the second project to form the second design.

7. The method of claim 6 further comprising, after repopulating the first design in the second project, removing the one or more linked IFCs from the second project, or hiding the one or more linked IFCs from view.

8. The method of claim 1 wherein each of the one or more exported model files corresponds to a storey of the first building design, such that an imported model file is linked to each storey of the first design in the second project.

9. The method of claim 8 wherein the one or more model files are aligned or stacked vertically, wherein the order of the one or more model files corresponds to the storey of the first design in the second project.

10. The method of claim 1 wherein the one or more objects are one or more of: furniture, fixtures, equipment, mechanical equipment, electrical equipment, electrical fixtures, public health, plumbing, empty rooms, or predesigned rooms; and wherein the first design is repopulated in a software application.

11. A method for compressing a 3D model, comprising:
associating each of a plurality of objects within a 3D model with one of a plurality of groups, wherein the plurality of groups comprises a first group and a second group;
determining a decimation range for each of the first and second groups, wherein the decimation range determines a proportion of polygons in each object within each of the first and second group to be removed;
removing one or more polygons from the objects of the first and second group, such that a compressed model is formed;
exporting the compressed model as a first file; and
exporting decimation information as a second file.

12. The method of claim 11 further comprising, prior to removing one or more polygons from the model, centring the model on the origin and determining the coordinates of the 3D object.

13. The method of claim 11, further comprising calculating the area of the model and height of the model, wherein the calculations are performed prior to removing the one or more polygons from the objects.

14. The method of claim 13 wherein the method further comprises calculating the grid size and if it is determined that the model does not fit a predetermined grid, rescaling or stretching the model to fit the predetermined grid, wherein the calculation is performed prior to removing the one or more polygons from the objects.

15. The method of claim 11 wherein the method further comprises optimising the model prior to removing the one or more polygons from the object, wherein the optimisation comprises one or more of: removing duplicated objects, removing duplicated materials, repairing any topology of the model, and repairing any CAD models.

16. The method of claim 11 further comprising, prior to determining a decimation range:
identifying one or more duplicate faces and/or one or more extra polygons contained within the model; and
removing the identified duplicate faces and/or extra polygons.

17. The method of claim 11 further comprising determining a category for each of the plurality of objects, wherein each category comprises one or more groups, and the decimation range for each of the one or more groups is individually determined.

18. The method of claim 11 wherein the decimation information comprises the number of polygons in the initial 3D model, and the decimation range for each of the first and second groups in each category, model width, model depth, model height, model area, space name, Space Description, Space Long Name, Space Clear Height or Space Gross Volume.

19. The method of claim 11 wherein exporting the compressed model comprises exporting the model as a GL Transmission Format Binary (GLB) file.

20. A system for repopulating a digital design of a building, the system comprising:
an input interface configured to receive one or more model files exported from a first application, the one or more model files corresponding to a first building design in a first project, the one or more model files comprising at least a geometry of the building and the first building design comprising one or more objects;
a processor configured to import the exported one or more model files into a second project;
wherein the processor is further configured to import, into the second project, one or more object files corresponding to the one or more objects within the first building design; and
wherein the processor is further configured to repopulate the first design into the second project by matching the one or more imported object files to the one or more model files.
